(19) United States
(12) Patent Application Publication
(10) Pub. No.: US 2009/0178004 A1
(43) Pub. Date: Jul. 9, 2009

(54) METHODS AND SYSTEMS FOR WORKFLOW MANAGEMENT IN CLINICAL INFORMATION SYSTEMS

(75) Inventors: William Murray Stoval, III, Draper, UT (US); Vijayanand Tirumalai, Draper, UT (US)

Correspondence Address: MCANDREWS HELD & MALLOY, LTD, 500 WEST MADISON STREET, SUITE 3400, CHICAGO, IL, 60661, US

(73) Assignee: GENERAL ELECTRIC COMPANY, Schenectady, NY (US)

(21) Appl. No.: 11/969,020

(22) Filed: Jan. 3, 2008

(51) Int. Cl. G06F 3/048

(52) U.S. Cl. 715/812

(57) ABSTRACT

Certain embodiments of the present invention provide methods and systems for providing clinical display and search of electronic medical data from a variety of information systems. Certain embodiments provide a user interface system including a processor operating a plurality of electronic clinical functionalities; an input allowing a user to enter data and operate clinical functionalities; a learning module maintaining a record of user selected functionalities; and a display output providing a functionality interface and a selection interface to a user. Certain embodiments provide a method for navigating among a plurality of functionalities in an electronic clinical application by maintaining a record of a user's navigation history and generating an array of functionality links based on the record.

### RELATED APPLICATIONS

[Not Applicable]

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

The present invention generally relates to aggregating viewing patient data. More particularly, the present invention relates to methods and systems navigating a user through multiple clinical display and search applications for electronic medical data collected from a variety of disparate information systems.

Healthcare has become increasingly centered on electronic data and records management. Healthcare environments, such as hospitals or clinics, include information systems, such as healthcare information systems (HIS), radiology information systems (RIS), clinical information systems (CIS), and cardiovascular information systems (CVIS), and storage systems, such as picture archiving and communication systems (PACS), library information systems (LIS), and electronic medical records (EMR). Information stored may include patient medical histories, imaging data, test results, diagnosis information, management information, and/or scheduling information, for example. The information for a particular information system may be centrally stored or divided at a plurality of locations. Healthcare practitioners may desire to access patient information or other information at various points in a healthcare workflow.

Robust clinical information system software applications typically support clinical users performing a wide range of workflows and interacting with significant volumes of clinical information. In a conventional clinical application, a single workflow (such as discharging a patient from an emergency room) might involve a user executing multiple tasks. Execution of multiple tasks often requires the user to navigate to several different parts of the application in order to perform each step of that workflow. Navigating through such complex software systems can be challenging if the user is unsure where to go within the application to perform the specific task. Such navigation can also be tedious, as the system may require the user to perform several actions (e.g., mouse clicks) to get the application properly configured to perform the task. Finally, for many clinical workflows, there may be more than one clinical user performing tasks that relate to the specific workflow. It can be difficult for multiple users to visualize which tasks have been completed already, and which ones remain to effectively coordinate their efforts.

Existing clinical information systems have incorporated features that try to improve usability of these complex systems. To-do lists, clinical decision support, and workflow engines have been implemented to help automate some of the work that needs to be accomplished during the execution of complex workflows. No product, to date, has combined these features into a user-centric workflow management system that provides navigation options anticipated to be selected by a user.

### BRIEF SUMMARY OF THE INVENTION

Certain embodiments of the present invention provide methods and systems for providing clinical display and search of electronic medical data from a variety of information systems.

Certain embodiments present a user interface system displaying an electronic clinical record comprising: a processor for operating a plurality of electronic clinical functionalities; an input allowing a user to enter data and access said plurality of electronic clinical functionalities; a learning module maintaining a record of said electronic clinical functionalities selected by a user and generating ordering criteria; a display output providing a functionality interface and a selection interface displaying one or more functionality links for executing electronic clinical functionalities upon user selection; wherein the functionality links are arranged in an array based on the ordering criteria.

Certain embodiments present a method of navigating among multiple functionalities within an electronic clinical application comprising: providing a user interface for receiving user entered data and user selected functionality commands; executing the functionalities based upon a user's selection the user functionality commands; maintaining a record of user entered functionality commands; generating a sorting criteria based on the record; sorting an array of functionality commands based on the generated sorting criteria; and displaying the array of functionality commands on the user interface.

Certain embodiments present a computer readable medium having a set of instructions for execution on a computer comprising: a user interface routine displaying an array of links causing an electronic clinical functionality to execute when selected by a user; a application routine displaying an electronic clinical record providing clinical data aggregated from a plurality of information sources and accessible by a user through the interface routine; a learning routine maintaining a record of the links selected by a user and generating sorting criteria based on the record; and a sorting routine facilitating navigation and manipulation of the functionalities and generating the array of links based on criteria generated by the learning routine.

### BRIEF DESCRIPTION OF SEVERAL VIEWS OF THE DRAWINGS

FIG. 1 illustrates an exemplary workflow diagram for a patient arriving in an Emergency Department.

FIG. 2 illustrates an exemplary user interface showing task links to facilitate user workflow in accordance with an embodiment of the present invention.

FIG. 3 illustrates a system for clinical data storage and electronic clinical application operation in accordance with an embodiment of the present invention.

FIG. 4 illustrates a flow diagram for a method for providing a workflow task list and other information for selection by a user via a user interface in accordance with an embodiment of the present invention.

FIG. 5 illustrates another exemplary user interface showing task links as buttons to facilitate user workflow in accordance with an embodiment of the present invention.

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION OF THE INVENTION

Certain embodiments provide systems and methods facilitating full clinical display and search of an electronic clinical record data, for example, a patient's medical record, from a variety of disparate information systems. In certain embodiments, a worklist or browser queries one or more enterprise hospital information systems. The worklist or browser aggregates the queried data into a single, interactive window that displays information, tasks, workflow execution steps, and/or other information from a particular patient and/or action search.

In certain embodiments, the worklist/browser can display information from systems such as Radiology, Cardiology, Pharmacy, Medication, and Lab information systems as well as Picture Archiving and Communication systems and/or other clinical information systems. Current systems do not allow flexibility and breadth in connected and queried information systems.

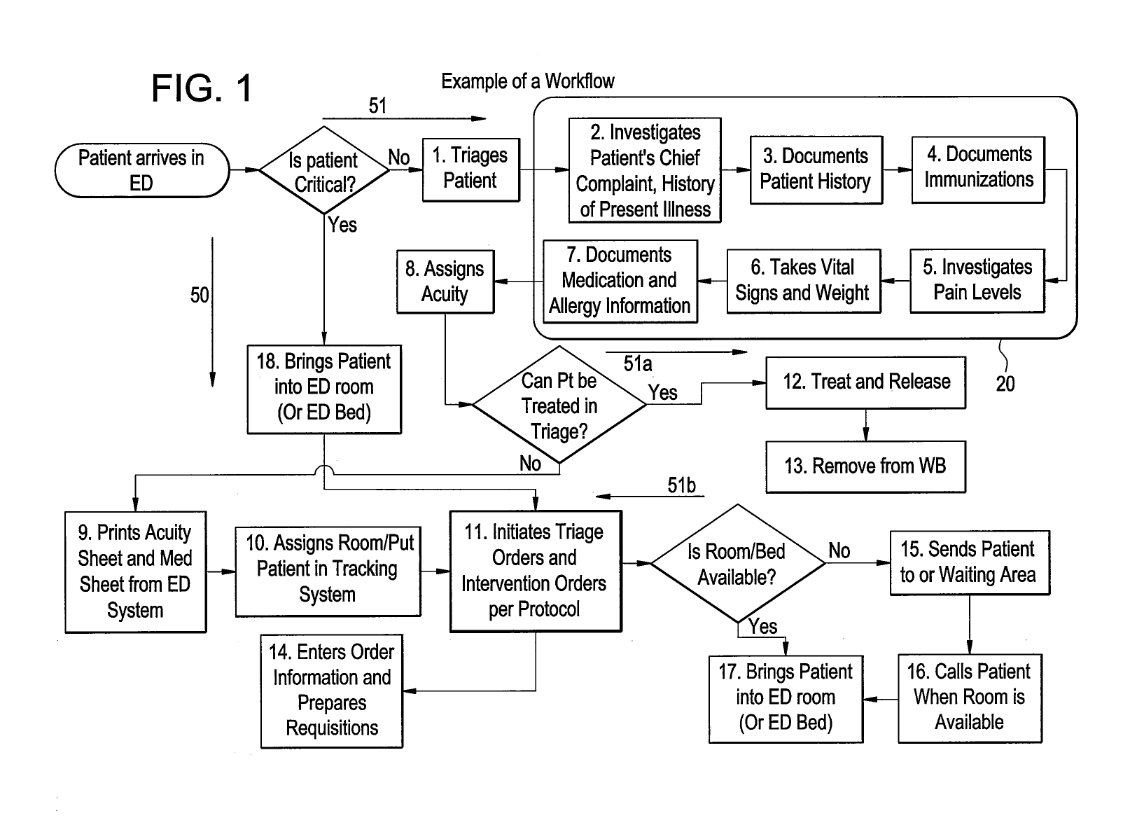

FIG. 1 depicts a flow diagram of an example workflow for a patient arriving in a healthcare facility, such as an emergency department (ED). Depending on certain circumstances surrounding a patient or a situation, a workflow may proceed in a number of directions, and take on a number of tasks. For example, a patient that is considered to be in critical condition may follow workflow path 50, for example, in order to expedite treatment for patients in need for immediate treatment. In the example workflow depicted in FIG. 1, if the patient is deemed to be in critical condition, the user's first workflow step, step 18, involves bringing the patient into an ED room, or an ED bed. After bringing the patient to the ED bed, the user in the example embodiment may proceed to workflow step 11 and take the critical patient, to initiate triage orders and intervention orders. Following this step, the user enters order information and prepares requisitions in step 14, completing the critical patient workflow in the example.

On the other hand, if the patient is not deemed to be in critical condition, the user may follow workflow path 51 beginning with workflow step 1. Because the patient is not deemed to be critical, the exemplary workflow path 51 comprises more steps and is more thorough because time and urgency may be less of a factor. In workflow step 1, the user may triage the patient without bringing the patient to an ED bed. Taking this workflow path, the user will proceed to step 2 to investigate the patient's chief complaint and the history of the present illness. This step may be done through questioning of the patient, or a patient's guardian or caretaker. Next, the user may proceed to step 3, where the user may document the patient's history by obtaining records of the patients previous hospital visits. Next, the user may proceed to step 4, where the user documents the patient's immunizations. For example, the user may obtain a document that indicates whether the patient is up to date on all immunizations and vaccinations. Next, the user may proceed to step 5 of the example workflow, and investigate the patient's pain levels. This may be done by simple questioning of the patient, for example. Next, the user may proceed to step 6 and take the vital signs and weight of the patient. Following step 6 the user may proceed to step 7, where the user may document medication and allergy information, and may store the information into a database, for example. In certain embodiments, steps 2 through 7 may be considered collectively to be one large step, for example step 20, gathering patient information. Following step 7 the user in the example workflow may assign and document the patient's acuity, or alertness level.

Based on the information gathered in steps 1-8 the user and the system may determine whether the patient may be treated in Triage. If the patient may be treated in triage the user proceeds with workflow path 51a, where the patient is treated and released in step 12, then removed from the whiteboard (WB), an electronic and erasable medium depicting which patient is currently in which bed, in step 13.

In embodiments where the patient may not be treated in triage, the user may proceed along workflow path 51b. For example, the user may first print an acuity sheet and medical sheet from the ED system in step 9, and then assign a room and enter the patient into the tracking system in step 10. Following step 10, the user may proceed next to step 11, where the user may initiate triage orders and intervention orders per protocol. Note that in this embodiment, step 11 along workflow path 51b is the same as step 11 along workflow path 50. Following step 11, a user may determine whether an ED room or an ED bed is available for patient use. If there a room or bed is available, the user may proceed to step 17 and brings the patient into the room. If, however, no room is available, the user may proceed to step 15 and send a patient to a waiting area until a waiting room becomes available. Next, once a waiting room comes available, the user may, in step 16, call the patient. Next the user may proceed to step 17 and brings the patient into the ED bed.

The example workflow described above is only to provide a sample of how a workflow may operate. Certain steps in the workflow may be omitted, skipped, repeated, or new steps added in certain embodiments. In certain embodiments, a user may proceed through a workflow in another order. In certain embodiments, the user may proceed from the example workflow or another workflow into another workflow once the patient is in the ED room, or in an ED bed, for example. A workflow in a different department or at a different institution may not necessarily resemble the workflow of FIG. 1.

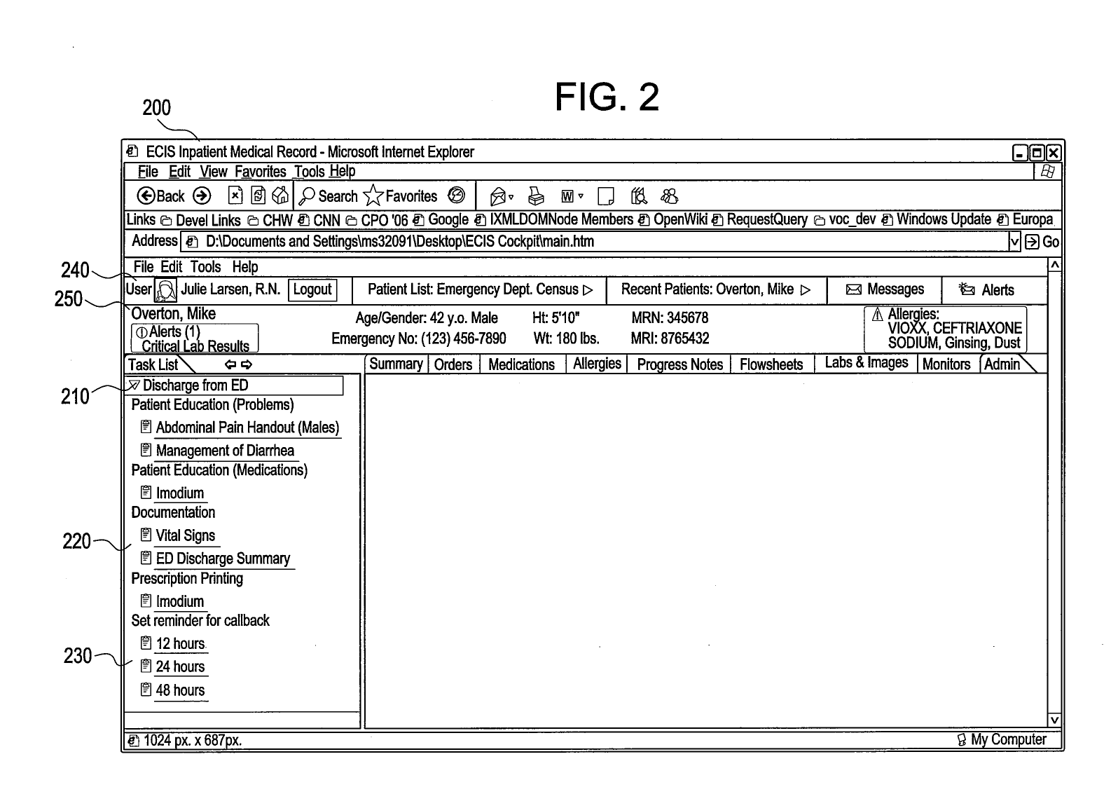

Certain embodiments of the present technology present a user interface providing functionality options that guide a user through a workflow, by determining the next likely functionality step or steps in the user's workflow, and presenting the functionalities as options to the user for selection via the user interface. Certain embodiments present a user interface, such as the user interface shown in FIG. 2, that integrates context-sensitive links pointing to areas of an application or workflow to which a user is likely to navigate. The system is aware of the user's current workflow (e.g., ‘discharge patient from Emergency Room’). The system is also aware of actions that may and/or may not need to be done and/or might be done for a clinical task, such as treatment of a patient. Furthermore, the system is aware of actions that the user may want (and/or need) to do for a patient population in which he/she is working. Indicators, or links present in the user interface serve as shortcuts (or ‘hyperlinks’). When selected by the user, an indicator or link allows the user to open, execute and/or access a specific function or functionality within the application or workflow that supports performing the selected task. When the user is finished with one task, or even prior to completion of the task, if the user desires, another shortcut may be selected from the list, helping the user execute a series of steps required for the given workflow.

For example, an emergency department (ED) nurse may be looking at a high level ‘white board’ summary view of all patients in the ED. The white board display shows that one of the nurse's patients is ready to be discharged. Once the nurse clicks on the discharge status indicator, a clinical application driving the white board recognizes that there is a “discharge patient from ED” workflow available. In response, a shortcut panel interface (such as that shown in FIG. 2) appears which presents the user with several links to those areas of the clinical application (or applications) that the nurse is likely going to use to discharge the patient. In this example, the nurse may be shown links to patient handout materials that relate to the admitting diagnoses for this patient. If there are medication prescriptions that need to be or should be provided to the patient, links may appear that allow the nurse to print those prescriptions out for the patient and/or otherwise transmit them for disbursement to the patient.

Other steps that are routinely performed for patients with relevant presenting problems may also appear via the interface. For example, one or more links that facilitate generation of a callback reminder may be shown. Later, the nurse may wish to order a dose of digoxin and/or other medication for a patient. Because that medication can cause problems if the patient has a low potassium level, the user interface presents the user with options to view previous potassium levels, order a potassium level, and/or order a serum digoxin level, for example.

In certain embodiments, a list or lists of shortcuts appearing in the user interface may not necessarily serve as a conventional ‘task list’ in that the user may not need to, or wish to, execute each of the tasks on the list. The user interface may render a task shortcut differently, however, if the task is already completed, to give the user a better sense of which tasks in the workflow are completed and which are left undone, for example.

In certain embodiments, a list or lists of links or shortcuts may be provided based on an assessment of which tasks are more likely to be selected next by a user. In these embodiments, a module may operate as a learning module that records and analyzes user's browsing history. In these embodiments, the learning module may generates a link, or a list of links incorporating shortcuts to those areas or functionalities of the application that the user is likely to select next.

For example, after medical prescriptions are provided to a patient, the browsing history for an ED nurse may indicate that after medications have been prescribed to a patient, the nurse has elected to print out those prescriptions 70% of the time as the next step, has elected to discharge the patient as the next step 28% of the time, and has elected a variety of different functions as the next step the remaining 2% of the time. In this embodiment, the learning module may generate a list of links including both the printing and discharging functions.

In another embodiment, the learning module may assign labels to certain links based on their likelihood of selection. Where a user elects to print prescriptions as the next step 70% of the time following a medication prescription, the system may assign the printing function a label, for example, the “primary” option. The label may include additional or modified navigational or task selection rules. For example, the “primary” option in the example embodiment my include rules allowing be the link for the “primary” option to be easier to select from a user interface perspective than other options. For example, the “primary” option or options may be represented by “buttons” or large icons upon which a user may click to execute the option. In certain embodiments the labels may include rules that provide for an execution or selection of the “primary” option when a user presses the “enter” key on the keyboard, for example. Additionally, the learning module may also generate a link operating to discharge the patient as a “secondary” option. The secondary option may be easy to elect from a user interface perspective, though not as easy as the primary option. In certain embodiments, there may be multiple “primary” options, each provided with a label and method of selection distinguishable from other selection methods.

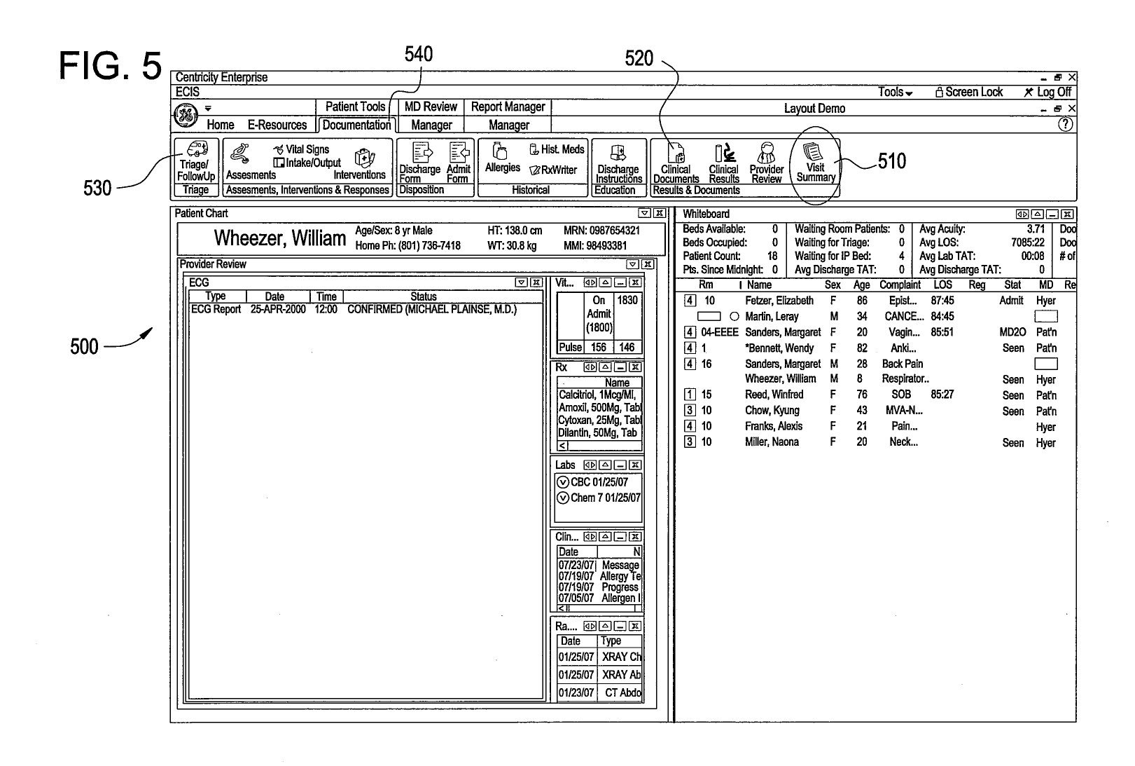

In certain embodiments, links to certain functions may be always, or nearly always present to the user in a user interface. For example, certain functions may be considered to be a “primary” or “secondary” option from any application or situation in the system. Accordingly, links to these functions may always be prominently offered to the user on the interface. FIG. 5 illustrates an exemplary user interface 500 showing task links to facilitate user workflow in accordance with an embodiment of the present invention. For example, in certain embodiments, a “visit summary” function may provide the user with the ability to confirm and/or view certain patient information without affecting any presently entered data or information, for example, by displaying a pop-up window displaying a summary of information pertaining to the patient visit. In certain embodiments such as the embodiment depicted in FIG. 5, a learning module may recognize that the present user of the system may have a high probability of accessing a particular function, for example, the “visit summary” function, from a any stage, application, program, or situation in the system. Accordingly, the depicted interface has presented a “visit summary” button 510 added to the toolbar near the top of the interface, serving as a link and providing a shortcut to the “visit summary” function, such that the user always has single click access to the visit summary function from the present any location of the user's workflow.

FIG. 5 also depicts a series of other buttons, or links. For example, a “clinical documents” button 520 is presented to provide a link to a function where the user may obtain and reference a series of patient related clinical documents. In certain embodiments, the “clinical documents” button 520 may be present during all operations of the user interface for a particular user. In certain other embodiments, the “clinical documents” button 520 or it may appear only during situations where the learning system recognizes that the user is likely to select the clinical documents feature. Likewise, a “Triage/Follow up” button 530 is also presented to provide a user with a link to a follow up function within the interface. In certain embodiments, the “Triage/Follow up” button 530 may be present, for example, only when the user has selected a documentation tab 540 on the user interface. In certain embodiments, where a user is handling patient billing records for example, the “Triage/Follow up” button 530 and the “clinical documents” button 520 may be absent from the interface 500, and replaced by other buttons or links that represent other functionalities, applications or programs, for example. In certain embodiments, when the buttons or links are not displayed on the interface, a user may still access the functions through other means, such as through use of pull down menus, or user entered commands, for example.

In another embodiment, the learning module may dynamically modify the presentation of links provided based on the user's history. As a user's selection characteristics may change as the user continues to use an application. Accordingly the learning module may, over time, dynamically update and modify the primary, secondary, tertiary and other options based on a user's navigation history. The dynamic nature of the learning module allows the workflow steps to be continually changing to coincide with changes in a user's workflows. In one embodiment, the learning module may generate links and assign priority labels to a function based on the user's entire history, and in another embodiment, it may base the assignments on a more recent history. For example, a nurse may have always elected to print as the next step following a prescription of medication for several years, but recently began a new practice of discharging patients as the next step following a prescription. In one embodiment, the learning module may recognize the change in the nurse's trend and reassign the discharge function as the primary option.

One or more lists of shortcuts, or potential tasks, may be defined within a clinical system as a series of ‘rules’. These rules can be authored and/or edited by clinical content creators at a software provider and/or at a customer site, for example. Execution of these rules is triggered by user events from within a clinical application as well as by changes to a clinical record itself, for example.

FIG. 2 illustrates an exemplary user interface 200 showing task links to facilitate user workflow in accordance with an embodiment of the present invention. As shown in FIG. 2, a user 240, such as a nurse (e.g., Julie Larsen as indicated on the interface 200 of FIG. 2), can click on or otherwise select a “discharge” status indicator for a patient 250 (e.g., Mike Overton) on an ED whiteboard screen to be taken to an interface 200 showing the patient's chart. The patient chart interface 200 includes a workflow management list window 210, shown here in an exemplary position on the left, for example. The array, or task list 210, provides a link 230 or links 230 to various places in one or more clinical applications that the user is likely to want and/or need to visit to discharge the patient and/or perform related actions, for example. In certain embodiments, the array may only comprise a single link. In other embodiments, such as that depicted in FIG. 2, the array, or task list 210, may comprise two or more links 230. In one embodiment, the links 230 provided are selected from an algorithm or a module such as a learning module that predicts the links likely to be chosen by a user based on that user's history. In another embodiment, a module may assign labels such as a “primary” option to a link that establishes a set of rules for executing the option.

The array, or task list 210, may be subdivided, for example, to reflect tasks involved in a particular workflow, such as a patient discharge workflow. As illustrated, for example, in FIG. 2, categories 320 such as patient education (problems), patient education (medications), documentation, prescription printing, and set reminder for callback may be used to group links for a user under a particular workflow. Within each category 320, links 230 are provided to guide the user through execution of tasks in a workflow. Looking at the interface 200 and task list 210 in FIG. 2, a patient discharge workflow is broken up into a plurality of categories 220 each having one or more tasks 230 that may or must be executed in order to complete the patient discharge. In certain workflows the task list may comprise elements standardized for all users.

In other embodiments, the task list 210 may be unique for each individual user, and adjustable for each user. In addition, in some embodiments the task list 210 may be modified dynamically by a learning module that uses an individual user's or all users' navigation histories to forecast the tasks items likely to be selected by a user given the circumstances (e.g., recent tasks performed, patient data history, time of day, etc.), and apply rules to operate and/or execute those tasks. For example, a rule may be applied to a task 230 that has determined by the learning module to be most likely to be selected by a user such that when the user presses the “enter” key the task 230 is selected.

By selecting a link 230, an appropriate action is taken for the user. For example, a nurse may select links 230 to provide prescription orders and/or information regarding Imodium, for example. The nurse may select other links 230 to obtain and/or generate vitals signs information, generate a discharge summary, and/or set a certain time reminder for a callback, for example.

Selecting a link 230 opens an application or functionality, accesses a clinical system, populates data, and/or produces an output, for example. A user may select a plurality of links 230 for the workflow within a single user interface 200, thus avoiding multiple logins for multiple systems, use of a plurality of interfaces to execute a single workflow, etc. Additionally, multiple users may be given access to the task list 210 via the interface 200 such that different users may execute different actions 230 within the workflow. In certain embodiments, links 230 to already-executed tasks may be represented differently from links 230 to not-yet-executed tasks such that a user may visually discern which actions 230 have been executed and which have not. In certain embodiments, multiple users may simultaneously execute tasks 230 via the interface 200 from different work stations.

In other embodiments, multiple users may access the interface 200 in sequence, with actions taken by prior users stored for reference by later users, for example. In other embodiments, the user interface may present links 230 based on the most commonly requested applications from users in the existing workflow.

In certain embodiments, “to do” or task lists, decision support options and feedback, and workflow output may be presented via the user interface 200, for example. A variety of information from a variety of sources may be centralized for a user via the interface 200, for example. In certain embodiments, state information for the interface 200 such that it is available for later retrieval and use. In certain embodiments, patient electronic medical record information may be modified via the interface 200, for example.

In certain embodiments, instead of and/or in addition to display of data and links in a chart-based format, information may be displayed in a tabular or column-based format, a timeline or chronological format integrated and/or separated based on category/type of information, etc., for example. The interface 200 may provide a browser or other interface having an ability to search and filter a patient's full electronic medical record so as to visualize a full context to a patient's health or pathology, for example. In certain embodiments, a single or unified display system that allows the display of a patient's complete electronic medical record at one time.

Certain embodiments allow a user to visualize patient medical data from a single work station and/or interface without having to log in to multiple work stations. For example, data is automatically retrieved and aggregated in advance and/or on request through communication with a plurality of underlying systems for display via a single interface. Having all the data accessible at one time also allows a user to display and visualize the data in a variety of informative layouts.

Additionally, certain embodiments provide a learning module that maintains separate user navigation records for each work station in addition to an overall navigation record, for example. Such an embodiment may be used, for example, where a user tends to practice different navigation schemes at a particular work station. For example, a nurse may operate two separate work stations on a particular system. At the first work station, which the nurse may visit far more often than the second work station, the nurse may examine a patient's allergy information as an initial step. At the second work station, which is seldom visited by the nurse, the nurse may initially examine a patient's prescription information. In this scenario, though the allergy information may be the most commonly selected initial functionality in the nurse's navigation history on the overall system, the learning module may provide an alternative list of links based on the nurse's navigation history at the second work station when the nurse is operating at the second work station.

In certain embodiments, users may view patient and/or workflow information at a high level to provide an overall view. From a high level overall vantage point, the user may navigate to any specific item on the patient's history by using a navigational cursor, mouse click, touch screen, voice command, gaze tracking, etc. The user can drill down to retrieve and/or otherwise view more detailed and/or specific information, for example.

In certain embodiments, comprehensive patient data points may be aggregated into a single location (e.g., a thumbdrive, CD, DVD, hard drive, etc.). Export capability from a plurality of clinical applications allows aggregation and storage of information to a single locale. In certain embodiments, a patient medical record may include aggregated information from a plurality of information systems under a common patient context. Information systems may include a radiology information system (RIS), a picture archiving and communication system (PACS), Computer Physician Order Entry (CPOE), an electronic medical record (EMR), Clinical Information System (CIS), Cardiovascular Information System (CVIS), Library Information System (LIS), and/or other healthcare information system (HIS), for example. An interface facilitating access to the patient record may include a context manager, such as a clinical context object workgroup (CCOW) context manager and/or other rules-based context manager. Components may communicate via wired and/or wireless connections on one or more processing units, such as computers, medical systems, storage devices, custom processors, and/or other processing units. Components may be implemented separately and/or integrated in various forms in hardware, software and/or firmware, for example.

Certain embodiments may be used to provide an integrated solution for application execution and/or information retrieval based on rules and context sharing, for example. For example, context sharing allows information and/or configuration options/settings, for example, to be shared between system environments. Rules, for example, may be defined dynamically and/or loaded from a library to filter and/or process information generated from an information system and/or an application.

Information for a particular patient may be extracted and/or linked from one or more information systems for presentation to a user via a unified patient interface, for example. In certain embodiments, information retrieval, display and/or processing settings, for example, may be customized according to a particular user or type of user. Retrieval, aggregation, display and/or processing of information may be based on rules, preferences, and/or other settings, for example. Rules, preferences, settings, etc. may be generated automatically based on preset parameters and/or observed data, for example. Rules, preferences, settings, etc., may be created by a system administrator or other user, for example. Rules, preferences, settings, etc., also may be manually and/or automatically adapted based on experiences, for example. Rules, preferences, settings, etc., also may be adapted based on an individual user's navigation history or task execution history, for example. Rules, preferences, settings, etc., may additionally be adapted based on all users' navigation histories or task execution histories, for example.

In certain embodiments, a user may log on any one of the connected systems and/or a separate system to access information found on all of the connected systems through context sharing and a unified user interface. In certain embodiments, information may be filtered for easier, more effective viewing.

In certain embodiments, a user interface providing a patient or other clinical record may work together with a perspectives management system for handling multiple applications and workflow, for example. The perspectives management system allows various perspectives to be defined which save workflow steps and other information for a particular user. Perspectives may be used to save visual component positioning information and interactions based on workflow, for example. Perspectives allow relevant information to be presented to a user.

In certain embodiments, perspectives may be based upon the navigation history, or task selection history of a user. In certain embodiments, a learning module or a perspectives management system may maintain a navigation record of the functionalities, workflow steps, and tasks accessed and/or operated and/or executed by a particular user. The learning module or perspectives management system may define various perspectives based on an analysis of all the information in the navigation record.

For example, a particular user's navigation record may indicate that, once the patient discharge process is initiated, 50% of the time the user has printed out patient prescriptions, 30% of the time the user has created a final assessment to the patient history, 15% of the time the user has obtained a patient signature form, and 5% of the time the user has faxed a prescription to a pharmacy. In an example embodiment the perspectives management system may provide a perspective offering an array of links for:
1) printing of prescriptions;
2) adding to patient history;
3) printing a patient signature form; and
4) faxing or forwarding prescriptions, for example.

A perspective in an example embodiment may provide for a user to access the user's most commonly selected tasks quickly and easily without having to dig down or access various pull down menus, for example. In certain embodiments, the learning module may continually update the navigation record to dynamically provide perspectives based on a user's likely selected tasks. For example, the user in the above example may, due to a change in policy, desire to execute a payment function as the first step of the discharge process. The learning module may update the user's navigation record, such that the next time the user initiates a discharge process, a payment function is among the links provided to the user in the perspective, for example.

When first starting up the system, the user may, for example, run through a sample workflow. This initial run through may then establish the links or tasks selected by the user as the primary navigation option because the navigation record consists only of one episode selected by the user, for example. The next time a user runs through the system, the option established as the primary navigation option may become the default option, for example.

In certain embodiments the navigation record may be aggregated for a department as opposed to a single user. The departmental navigation record may be to apply to a new user, so that a new user's perspective includes links based upon the aggregation of the usage in the department, for example. In certain embodiments, the perspective or links presented to an individual user may be based both on the user's usage history and the department's history.

In certain embodiments, a clinical information system may include one or more patient records. In certain embodiments, a patient record provides identification information, allergy and/or ailment information, history information, orders, medications, progress notes, flowsheets, labs, images, monitors, summary, administrative information, and/or other information, for example. The patient record may include a list of tasks for a healthcare practitioner and/or the patient, for example. The patient record may also identify a care provider and/or a location of the patient, for example.

In certain embodiments, an indication may be given of, for example, normal results, abnormal results, and/or critical results. For example, the indication may be graphical, such as an icon. The user may select the indicator to obtain more information. For example, the user may click on an icon to see details as to why a result was abnormal. The user may be able to view only certain types of results. For example, the user may view only critical results. Similarly, actions or tasks having varying degrees of importance may be represented using different indications. Actions or tasks having varying degrees of completion may also be represented using different indications, for example.

In certain embodiments, a unified user interface is in communication with one or more applications and/or information systems, for example. The unified user interface interacts with individual interfaces for the application(s) and/or system(s) and masks or hides the individual interfaces from a user. That is, the user sees and interacts with the unified user interface rather than the underlying individual interfaces. A user may be authenticated at the unified user interface. Authentication at the unified user interface may propagate through the connected application(s) and/or system(s), for example.

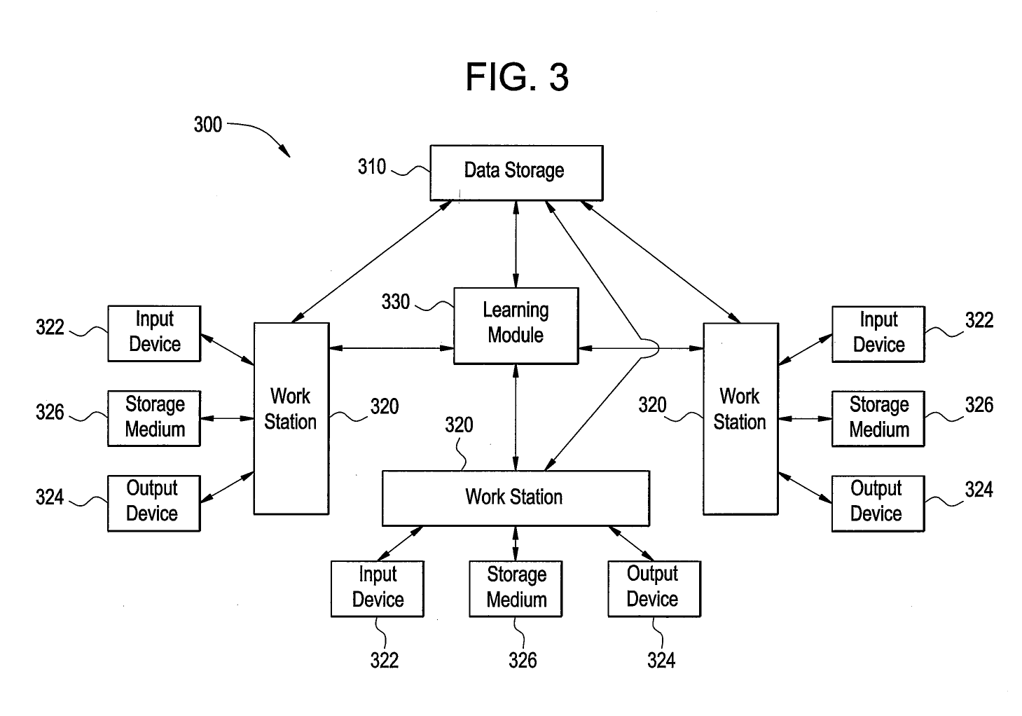

FIG. 3 illustrates an electronic clinical information system for clinical data storage and workflow management in accordance with an embodiment of the present invention. In certain embodiments, an interface including clinical or patient information and tasks may be viewed and/or constructed using a system such as system 300 including at least one data storage 310, at least one work station 320 and a learning module 330. While three work stations 320 are illustrated in system 300, a larger or smaller number of work stations 320 can be used in accordance with embodiments of the presently described technology. In addition, while one data storage 310 and one learning module 330 are illustrated in system 300, system 300 can include more than one data storage 210 and more than one learning module 330. For example, each of a plurality of entities (such as remote data storage facilities, hospitals or clinics) can each include one or more data stores 310 and learning modules 330 in communication with one or more work stations 320.

As illustrated in system 300, one or more work stations 320 can be in communication with at least one other work station 320 and/or at least one data storage 310. Work stations 320 can be located in a single physical location or in a plurality of locations. Work stations 320 can be connected to and communicate via one or more networks.

Work stations 320 can be directly attached to one or more data stores 310 and/or communicate with data storage 310 via one or more networks. In addition, work stations 320 can be directly attached to one or more learning modules 330 and/or communicate with learning modules 330 via one or more networks. Each work station 320 can be implemented using a specialized or general-purpose computer executing a computer program for carrying out the processes described herein. Work stations 320 can be personal computers or host attached terminals, for example. If work stations 320 are personal computers, the processing described herein can be shared by one or more data stores 310 or learning modules 330 and a work station 320 by providing an applet to work station 320, for example.

Work stations 320 include an input device 322, an output device 324 and a storage medium 326. For example, work stations 320 can include a mouse, stylus, microphone and/or keyboard as an input device. Work stations 320 can include a computer monitor, liquid crystal display (“LCD”) screen, printer and/or speaker as an output device.

Storage medium 326 of work stations 320 is a computer-readable memory. For example, storage medium 326 can include a computer hard drive, a compact disc (“CD”) drive, a USB thumb drive, or any other type of memory capable of storing one or more computer software applications. Storage medium 326 can be included in work stations 320 or physically remote from work stations 320. For example, storage medium 326 can be accessible by work stations 320 through a wired or wireless network connection.

Storage medium 326 includes a set of instructions for a computer. The set of instructions includes one or more routines capable of being run or performed by work stations 320. The set of instructions can be embodied in one or more software applications or in computer code.

Data storage 310 can be implemented using a variety of devices for storing electronic information such as a file transfer protocol (“FTP”) server, for example. Data storage 310 includes electronic data. For example, data storage 310 can store EMRs for a plurality of patients. Data storage 310 may include and/or be in communication with one or more clinical information systems, for example.

Learning module 230 may consist of a data store, such as data storage 310 and a processor for aggregating and manipulating data. Learning module 330 may be a perspectives management system as described above. Learning module 330 may provide a record of a user's navigation history, such as a database, for example. Learning module 330 may also include a processor for analyzing the navigation record to determine which functions, links, workflow steps, etc., a user is likely to select at each stage of a workflow. In certain embodiments, learning module 330 may be a processor analyzing information within data storage 310, and storage mediums 326 from individual work stations 320.

In certain embodiments, learning module 330 may maintain and analyze a record of an entire department's navigation history instead of or in addition to the record for each individual user.

Communication between work stations 320, work stations 320 and data storage 310, and/or a plurality of data stores 310, work stations 320 and a learning module 3230, and/or a plurality of learning modules 330, and data storage 320 and/or a plurality data stores 320 and a learning module 330 and/or a plurality of learning modules 330 can be via any one or more types of known networks including a local area network (“LAN”), a wide area network (“WAN”), an intranet, or a global network (for example, Internet). Any two of work stations 320, data stores 310 and learning modules 330 can be coupled to one another through multiple networks (for example, intranet and Internet) so that not all components of system 300 are required to be coupled to one another through the same network.

Any work stations 320 and/or data stores0 and/or learning modules 330 can be connected to a network or one another in a wired or wireless fashion. In an example embodiment, work stations 320, data store 310 and learning module 330 communicate via the Internet and each work station 320 executes a user interface application to directly connect to data store 310 and learning module 330. In another embodiment, work station 320 can execute a web browser to contact data store 310 and learning module 330. Alternatively, work station 320 can be implemented using a device programmed primarily for accessing data store 3210 and learning module 330. In another embodiment, learning module 330 may consist of a processor connected via a network to data store 310 with the ability to access and manipulate data stored in data store 310 pertaining to a user's navigation history, for example.

Data storage 310 can be implemented using a server operating in response to a computer program stored in a storage medium accessible by the server. Data storage 310 can operate as a network server (often referred to as a web server) to communicate with work stations 320 and learning module 330. Data storage 310 can handle sending and receiving information to and from work stations 320, and to and to and from learning module 330 and can perform associated tasks. Data storage 310 can also include a firewall to prevent unauthorized access and enforce any limitations on authorized access. For instance, an administrator can have access to the entire system and have authority to modify portions of system 300 and a staff member can only have access to view a subset of the data stored at data store 310. In an example embodiment, the administrator has the ability to add new users, delete users and edit user privileges. The firewall can be implemented using conventional hardware and/or software.

Data store 310 can also operate as an application server. Data store 310 can execute one or more application programs to provide access to the data repository located on data store 310 or learning module 330. Processing can be shared by data store 310, work stations 320 and learning module 330 by providing an application (for example, a java applet). Alternatively, data store 310 can include a stand-alone software application for performing a portion of the processing described herein. It is to be understood that separate servers may be used to implement the network server functions and the application server functions. Alternatively, the network server, firewall and the application server can be implemented by a single server executing computer programs to perform the requisite functions.

The storage device located at data storage 310 can be implemented using a variety of devices for storing electronic information such as an FTP server. It is understood that the storage device can be implemented using memory contained in data store 310 or it may be a separate physical device. The storage device can include a variety of information including a data warehouse containing data such as patient medical data, for example. Similarly, the storage device located at learning module 330 can be implemented using memory contained in learning module 330, in data store 310, in storage mediums 326 or it may be a separate physical device.

Data storage 310 can also operate as a database server and coordinate access to application data including data stored on the storage device. Data storage 310 can be physically stored as a single database with access restricted based on user characteristics or it can be physically stored in a variety of databases.

In an embodiment, data storage 310 is configured to store data that is recorded with or associated with a time and/or date stamp. For example, a data entry can be stored in data storage 310 along with a time and/or date at which the data was entered or recorded initially or at data storage 310. The time/date information can be recorded along with the data as, for example, metadata. Alternatively, the time/date information can be recorded in the data in manner similar to the remainder of the data. In another alternative, the time/date information can be stored in a relational database or table and associated with the data via the database or table.

In certain embodiments, learning module 330 is configured to store data associated with a time and/or date stamp. For example, a navigation record entry can be stored in learning module 330 along with a time and/or date at which the entry was entered or recorded initially at learning module 330. The time/date information can be recorded along with the navigation record as, for example, metadata. Alternatively, the time/date information can be recorded in the record in manner similar to the remainder of data. In another alternative, the time/date information can be stored in a relational database or table and associated with the data via the database or table. In certain embodiments, learning module 330 considers the time/date data, for example, in determining a list of workflow steps to present to a user.

In an embodiment, data storage 310 is configured to store medical data for a patient in an EMR. The medical data can include data such as numbers and text. The medical data can also include information describing medical events. For example, the medical data/events can include a name of a medical test performed on a patient. The medical data/events can also include the result(s) of a medical test performed on a patient. For example, the actual numerical result of a medical test can be stored as a result of a medical test. In another example, the result of a medical test can include a finding or analysis by a caregiver that entered as text.

In certain embodiments, learning module 330 is configured to store data pertaining to a user's navigation history. For example, learning module 330 may maintain a navigation record indicating that a user, after executing a particular task (e.g. admitting new patient), has elected one task (e.g. assign patient a doctor) as the next step 100 times, and another task (e.g. record patient's insurance information) as the next step 400 times. The data in the navigation record can be used, for example, to anticipate the next tasks a user will choose to execute. In an embodiment the learning module 330 may aggregate a list of likely tasks, assign a label to each task, and present the list of tasks to the user via the work station 320 interface.

In operation, a user employs a work station 320 to display, on an output device 324, a patient chart and/or other interface aggregated from data and/or functionality stored at one or more data storage 310. The work station 320 facilitates filtering/search of the available data and provision of one or more associations among a plurality of the data and/or events visually represented to the user, for example. As described above, work station 320 includes computer-readable storage medium 326 that itself comprises a set of instructions for work station 320. The set of instructions can be embodied in one or more computer software applications or computer code. This set of instructions is used by work station 320 to access and display data and/or events and one or more associations among a plurality of the data/events. Thus, at least one technical effect of the set of instructions is to aggregate and provide data and functionality from one or more clinical systems so as to enable a user to more quickly and easily execute tasks in a workflow and review patient electronic medical record data, for example.

The set of instructions includes one or more software routines. In an embodiment, the set of instructions includes a display routine, a data routine and a filter routine. These routines operate to determine and display associations among related data/events on display device 324.

In certain embodiments, the set of instructions includes a user interface routine and a filter routine. The user interface routine displays an aggregated electronic patient record. The electronic patient record includes a plurality of data points related to a patient. The plurality of data points provides patient data aggregated from a plurality of information sources. The user interface routine provides access to and review of the plurality of data points within a single view. The filter routine filters the aggregated electronic patient record based on one or more terms provided by a user to generate filtered electronic patient record data displayable via the user interface routine.

In certain embodiments the set of instructions includes a user interface routine displaying a list, or an array of one or more functionality execution links, each of said one or more links causing an electronic clinical functionality (e.g., discharge a patient) to execute when selected by a user. In certain embodiments the set of instructions further includes an application routine. The application routine may display a clinical record such as a patient record to a user via a display unit. The displayed clinical record may be aggregated from a plurality of information sources. For example, a patient history record may include records of various illnesses, treatments, allergies and other information added by a plurality of users, at a plurality of different work stations 320.

In certain embodiments the set of instructions includes a learning routine that maintains a record of links, tasks, functions, workflow steps, etc., selected by a user or a plurality of users operating the system. In certain embodiments the learning routine generates a sorting criteria based on said record. For example, the learning routine may generate a provision to sort all tasks by the number of times selected by the user.

In certain embodiments the set of instructions further includes a sorting routine to facilitate user navigation among a plurality of tasks, functionalities, etc. In certain embodiments the sorting routine may rank the tasks according to criteria established by the learning routine. For example, the learning routine may generate sorting criteria produce the five selected tasks by the user based on the user's navigation record, and the sorting routine may then rank the tasks according to number of times selected by the user and generate a list of the five most selected tasks.

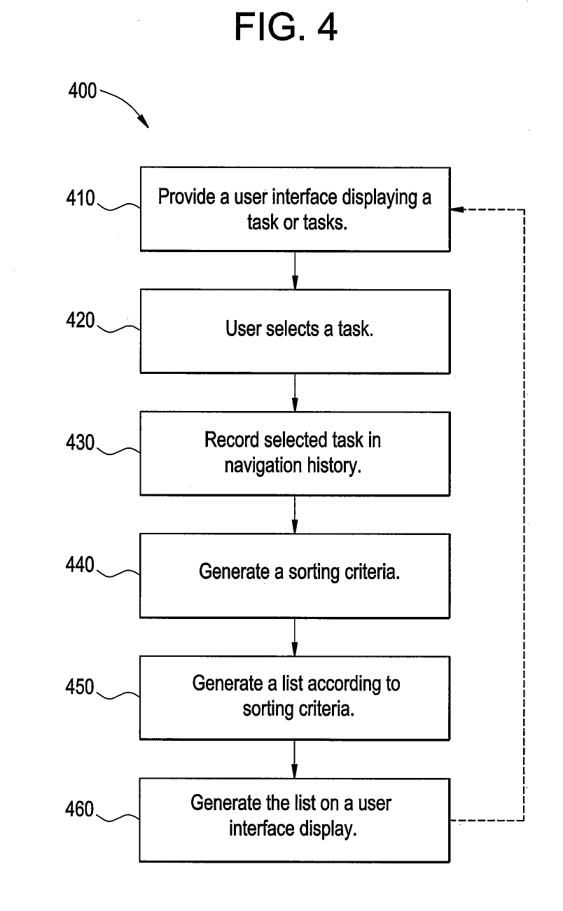

FIG. 4 illustrates a flow diagram for a method 400 for providing a workflow task list and other information for selection by a user via a user interface in accordance with an embodiment of the present invention.

At step 410, a user interface displaying at least one task for selection is provided to a user. In certain embodiments, at step 410 a user may enter data, commands, and retrieve previously entered data and aggregated, for example. For example, a user may enter information pertaining to a patient's diagnosis and treatment and then view a list of potential tasks to choose, such as print out a prescription, discharge patient, open a new patient history.

At step 420 a user elects a functionality, task, or workflow step for operation on the user interface provided in step 410. For example, a user may enter a command (e.g., clicking on a link) to print out a prescription, and the application executes the printing function. In certain embodiments a user may select a task from the list produced in step 410, or the user may select another task by another selection means. For example, a user may enter a search command via a searching function to locate a task that is not produced on the interface in step 410.

At step 430 the user's navigation history is recorded in a navigation record. In certain embodiments, at step 430 the user's navigation history may include data pertaining to each task, functionality, workflow step, etc., that the user has executed, operated, and/or visited, for example. For example, where a user elects to discharge a patient after printing out a prescription, method step 430 involves recording the selection and modifying the previous navigation record to increase the number of times a patient has been discharged following a prescription printing by one.

At step 440 a sorting criteria is generated from the navigation history. In certain embodiments, at step 440 the sorting criteria may set the terms for the number of tasks to be included and the order for which the tasks will be listed. For example, a navigation record may indicate that following a prescription printing task, the user has selected fifty different options at least once. A sorting criteria may then be generated requesting those tasks to be sorted by number of selections, and to produce the ten most commonly selected tasks in order of most to least commonly selected. Alternatively, a navigation record may indicate that following a patient admission task, the user has selected only five different options at least once. In this example, step 440 may generate a criteria requesting to produce only those five tasks, and to assign a “primary” label to the most commonly selected of those tasks, for example.

At step 450 a list of tasks may be produced and sorted according to the criteria established in step 440. In certain embodiments, at step 450 the tasks listed may be in the form of links that execute certain functionalities when selected, or clicked on, by a user.

At step 460 the list generated in step 450 is generated on a display. In certain embodiments, at step 460 the tasks displayed may be in the form of links that execute certain functionalities when selected, or clicked on, by a user. For example, at step 460 a user interface display 200 as depicted in FIG. 1 may generate a list of links 230, each link executing a task (e.g. educating patient, documenting vital signs, setting a callback reminder) in a column on the left side of the interface.

At step 460 the method cycles back to step 410 where the user may operate through the method again or end the present workflow. For example, a list is generated in step 460 on a user interface as it is in step 410. A user may, as, as in step 410, enter data via the user interface and then, as in step 420, select one of the links displayed in step 460, and the method will then continue on to step 430, for example.

One or more of the steps of the method 400 may be implemented alone or in combination in hardware, firmware, and/or as a set of instructions in software, for example. Certain embodiments may be provided as a set of instructions residing on a computer-readable medium, such as a memory, hard disk, DVD, or CD, for execution on a general purpose computer or other processing device.

Certain embodiments of the present invention may omit one or more of these steps and/or perform the steps in a different order than the order listed. For example, some steps may not be performed in certain embodiments of the present invention. As a further example, certain steps may be performed in a different temporal order, including simultaneously, than listed above.

One or more embodiments of the presently described invention provide several advantages. In certain embodiments, information can be aggregated from a variety of sources and present to the user in a unified format. In certain embodiments, information may be searched and/or filtered based on one or more criteria. In addition, using embodiments of the presently described technology, relevant information can be accessed without the uncertainty of accessing unrelated data/events that occur in close proximity to related data/events.

Certain embodiments provide improved productivity of a clinical user by facilitating easier and faster navigation of clinical applications and data and tracking of task status to indicate tasks that have been completed by another individual. Certain embodiments help reduce training costs for a customer in rolling out an application to new users through an easy-to-use task list interface system. Certain embodiments help provide improved patient safety and clinical outcomes due to incorporation of a user interface element that aggregates ‘decision support’ features with other ‘to do’ features. This allows the clinical user an opportunity to see what tasks are recommended for a patient. Decision support systems that are decoupled from the user interface may not be as likely to present output to the user in a meaningful way.

Certain embodiments provide for improved productivity by providing the tasks most likely to be selected next to be the most easily accessible option. For example, certain embodiments provide access to the most commonly selected tasks with fewer clicks, less reading time, less navigation time to make the selection, etc.

Certain embodiments provide for improved methods for educating healthcare and other professionals by generating and maintaining a navigational record of tasks that were selected in the treatment of each patient. The navigational record may be used, for example, for presentations and teaching situations in group settings of healthcare or other professionals on how different pathways of care compare for different care situations.

As opposed to other software systems offering task lists and workflows to users, certain embodiments provide task list links, computational workflow rules, and clinical decision support logic in a clinical application such that the output is presented to the user in a consistent, accessible, and aggregated manner and such that the user can act on the output via tight integration with the navigation structure of the clinical system. Additionally, certain embodiments provide a dynamic presentation of task lists and workflows such that the presentation adjusts to keep up with modifications in a user's navigation tendencies.

The components, elements, and/or functionality of the interface(s) and system(s) described above may be implemented alone or in combination in various forms in hardware, firmware, and/or as a set of instructions in software, for example. Certain embodiments may be provided as a set of instructions residing on a computer-readable medium, such as a memory or hard disk, for execution on a general purpose computer or other processing device, such as, for example, a PACS work station or one or more dedicated processors.

Several embodiments are described above with reference to drawings. These drawings illustrate certain details of specific embodiments that implement the systems and methods and programs of the present invention. However, describing the invention with drawings should not be construed as imposing on the invention any limitations associated with features shown in the drawings. The present invention contemplates methods, systems and program products on any machine-readable media for accomplishing its operations. As noted above, the embodiments of the present invention may be implemented using an existing computer processor, or by a special purpose computer processor incorporated for this or another purpose or by a hardwired system.

As noted above, certain embodiments within the scope of the present invention include program products comprising machine-readable media for carrying or having machine-executable instructions or data structures stored thereon. Such machine-readable media can be any available media that can be accessed by a general purpose or special purpose computer or other machine with a processor. By way of example, such machine-readable media may comprise RAM, ROM, PROM, EPROM, EEPROM, Flash, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such a connection is properly termed a machine-readable medium. Combinations of the above are also included within the scope of machine-readable media. Machine-executable instructions comprise, for example, instructions and data which cause a general purpose computer, special purpose computer, or special purpose processing machines to perform a certain function or group of functions.

Certain embodiments of the invention are described in the general context of method steps which may be implemented in one embodiment by a program product including machine-executable instructions, such as program code, for example in the form of program modules executed by machines in networked environments. Generally, program modules include routines, programs, objects, components, data structures, etc., that perform particular tasks or implement particular abstract data types. Machine-executable instructions, associated data structures, and program modules represent examples of program code for executing steps of the methods disclosed herein. The particular sequence of such executable instructions or associated data structures represent examples of corresponding acts for implementing the functions described in such steps.

Certain embodiments of the present invention may be practiced in a networked environment using logical connections to one or more remote computers having processors. Logical connections may include a local area network (LAN) and a wide area network (WAN) that are presented here by way of example and not limitation. Such networking environments are commonplace in office-wide or enterprise-wide computer networks, intranets and the Internet and may use a wide variety of different communication protocols. Those skilled in the art will appreciate that such network computing environments will typically encompass many types of computer system configurations, including personal computers, hand-held devices, multi-processor systems, microprocessor-based or programmable consumer electronics, network PCs, minicomputers, mainframe computers, and the like. Embodiments of the invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing the overall system or portions of the invention might include a general purpose computing device in the form of a computer, including a processing unit, a system memory, and a system bus that couples various system components including the system memory to the processing unit. The system memory may include read only memory (ROM) and random access memory (RAM). The computer may also include a magnetic hard disk drive for reading from and writing to a magnetic hard disk, a magnetic disk drive for reading from or writing to a removable magnetic disk, and an optical disk drive for reading from or writing to a removable optical disk such as a CD ROM or other optical media. The drives and their associated machine-readable media provide nonvolatile storage of machine-executable instructions, data structures, program modules and other data for the computer.

The foregoing description of embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principals of the invention and its practical application to enable one skilled in the art to utilize the invention in various embodiments and with various modifications as are suited to the particular use contemplated.

Those skilled in the art will appreciate that the embodiments disclosed herein may be applied to the formation of any clinical system. Certain features of the embodiments of the claimed subject matter have been illustrated as described herein; however, many modifications, substitutions, changes and equivalents will now occur to those skilled in the art. Additionally, while several functional blocks and relations between them have been described in detail, it is contemplated by those of skill in the art that several of the operations may be performed without the use of the others, or additional functions or relationships between functions may be established and still be in accordance with the claimed subject matter. It is, therefore, to be understood that the appended claims are intended to cover all such modifications and changes as fall within the true spirit of the embodiments of the claimed subject matter.

1. A user interface system displaying an electronic clinical record, said system comprising:
a processor operating a plurality of electronic clinical functionalities;
an input allowing a user to enter data and access said plurality of electronic clinical functionalities;
a learning module maintaining a record of said electronic clinical functionalities presently and previously selected by a user and generating ordering criteria;
a display output providing:
a functionality interface for operation of at least one of said electronic clinical functionalities; and
a selection interface for displaying an array comprising at least one functionality link for user selection, said at least one functionality link executing at least one of said electronic clinical functionalities upon user selection;
wherein said array is based on said ordering criteria.

2. The user interface system of claim 1 wherein said array comprises a plurality of functionality links, said array based on said ordering criteria.

3. The user interface system of claim 1 further comprising at least one electronic clinical functionality aggregating data relating to a clinical record from a plurality of information systems to form an aggregated electronic clinical record.

4. The user interface system of claim 3, wherein at least one of said electronic clinical applications automatically facilitates login to said plurality of information systems without user intervention.

5. The user interface system of claim 3, wherein said input allows a user to create associations between data.

6. The user interface system of claim 1, wherein said learning module updates said record and generates new ordering criteria following each said user functionality selections and each said user data entry.

7. The user interface system of claim 1, wherein said ordering criteria is based at least in part on the number of selections in said record for each of said plurality of electronic clinical functionalities.

8. The user interface system of claim 1, wherein said functionality interface and said selection interface may be displayed concurrently on a single output display.

9. The user interface system of claim 1, wherein said learning module maintains a multi-user record of electronic clinical functionalities selected by a plurality of users and generates ordering criteria based upon said record.

10. The user interface system of claim 1, wherein said learning module generates a likelihood of user selection for each of said electronic clinical functionalities based data in said record, and said array is displayed based on said generated likelihood of user selection.

11. The user interface system of claim 10, wherein the functionality link generated by said learning module to have the highest likelihood of user selection is provided a label to distinguish said link of highest likelihood from other links in said array.

12. The user interface system of claim 10 wherein said functionality link of highest likelihood is displayed in a font different from the font of other links in said array.

13. The user interface system of claim 12 wherein the functionality link generated by said learning module to have the second highest likelihood of user selection is displayed second from the top of said array.

14. The user interface system of claim 11 wherein said functionality of highest likelihood is assigned a set of rules for execution by said learning module.

15. A method of navigating among a plurality of functionalities within an electronic clinical application said method comprising:
Providing a user interface for receiving user entered data and a plurality of user selected functionality commands;
executing at least one of said plurality of functionalities based on the user selection of at least one of said user functionality commands;
maintaining a record of said user entered functionality commands;
generating a sorting criteria based on said record;
sorting an array of functionality commands based on said sorting criteria; and
displaying said array of functionality commands on said user interface.

16. The method of claim 15 wherein said functionality commands are at least one of a link, a hyperlink, or an indicator.

17. The method of claim 15, wherein said record further comprises data pertaining to a plurality of users.

18. The method of claim 15 wherein the generating a sorting criteria step further comprises calculating a probability of user selection for each of said plurality of functionality commands based on data in said record of user entered functionality commands.

19. The method of claim 18, wherein said displaying step further comprises determining a functionality command of highest probability of user selection from said plurality of functionality commands, and displaying said functionality command of highest probability at the top of said array.

20. A computer readable medium having a set of instructions for execution on a computer, said set of instructions comprising:
a user interface routine displaying an array of links, each of said links causing an electronic clinical functionality to execute when selected by a user;
a application routine displaying an electronic clinical record, said electronic clinical record including a plurality of data points related to a clinical task, said plurality of data points providing clinical data aggregated from a plurality of information sources, said interface routine providing access to and review of said plurality of data points within a single view;
a learning routine maintaining a record of said links selected by a user and generating one or more functionality sorting criteria based on said record; and
a sorting routine facilitating navigation and manipulation of said electronic clinical functionalities, said sorting routine generating said array of functionality execution commands based on one or more criteria generated by said learning routine.
